(19) United States
(12) Patent Application Publication
(10) Pub. No.: US 2013/0176213 A1
(43) Pub. Date: Jul. 11, 2013

(54) Touch-Screen Input/Output Device Techniques

(71) Applicants: Arman Toorians, San Jose, CA (US); Ali Ekici, Los Gatos, CA (US); Robert Collins, Morgan Hill, CA (US)

(72) Inventors: Arman Toorians, San Jose, CA (US); Ali Ekici, Los Gatos, CA (US); Robert Collins, Morgan Hill, CA (US)

(73) Assignee: NVIDIA CORPORATION, Santa Clara, CA (US)

(21) Appl. No.: 13/346,715

(22) Filed: Jan. 9, 2012

(51) Int. Cl. G06F 3/041; G06F 3/033

(52) U.S. Cl. 345/157; 345/173

(57) ABSTRACT

A state machine implemented method for operating a touch-screen input/output device includes determining charge levels from a touch sensor by scan logic. The charge levels from the touch sensor are converted to digital charge data by an analog-to-digital converter. Potential touch events and potential touch event location data is detected from the digital charge data by sensing logic. The potential touch events and potential touch event location data are compared to predetermined limits to determine touch events and locations that satisfy a predetermined level of accuracy by threshold management logic.

### BACKGROUND OF THE INVENTION

Computing systems have made significant contributions toward the advancement of modern society and are utilized in a number of applications to achieve advantageous results. Numerous devices, such as desktop personal computers (PCs), laptop PCs, tablet PCs, netbooks, e-readers, smart phones, servers, and the like have facilitated increased productivity and reduced costs in communicating and analyzing data in most areas of entertainment, education, business, and science. One common aspect of a number of computing systems is the touch-screen input/output interface. The touch-screen input/output interface includes a display and a touch sensor overlaid on the display. The display may typically be a cathode ray tube (CRT), liquid crystal display (LCD), plasma, light emitting diode (LED), or the like type display. The display is utilized to display items such as alphanumeric characters, icons, cursor, pictures, graphics, drawings and/or the like to a user. The touch sensor may typically be a resistive, capacitive, surface acoustic wave type touch sensor. The touch sensor is utilized to detect a localized activation (e.g., touch) by a user on the touch-screen input/output interface. In a number of cases the localized activation detected by the touch sensor corresponds to one or more items on the display. For example, the display may output a graphical user interface, including a plurality of selectable buttons, for an application. Touching a given button on the display by a user may be input to the application as a corresponding user input. The touch-screen input/output device therefore enables the user to interact directly with what is displayed, rather than indirectly through another input/output device such as a point device or navigation key.

Referring to FIG. 1, an exemplary computing device according to the conventional art is shown. The computing device 100 includes one or more processors 105 communicatively coupled to one or more memories 110, and one or more peripheral devices including a touch-screen input/output device 115-130. It is appreciated that the computing device 100 typically includes numerous other devices, components, peripherals, communication busses, and sub-systems, such as chip sets (e.g., northbride and southbride), volatile and non-volatile memories, network interfaces, and the like. The devices are not shown and discussed because they are well known in the art and not germane to an understanding of embodiments of the present technology.

The touch-screen input/output device 115-130 includes a display 115 and a touch sensor 120 overlaid on the display 115. The display 115 is communicatively coupled to one or more processors 105 through its corresponding display control module 125. The touch sensor 120 is communicatively coupled to one or more processors 105 through its corresponding touch sensor control module 130. The touch control module 130 includes a deducted processor. It is appreciated that the display 115, display control module 125, touch sensor 120 and touch control module 130 may be implemented as an external peripheral, may be implemented as an internal peripheral, or any other combination. The display control module converts video data into a serial bit stream. The touch control module detects touch events and the location of the touch events on the touch sensor. Typically the touch location is determined as an x-y coordinate based position.

Touch-screen input/output interface are becoming ever increasing more popular in computing devices such as smart phones, handheld gamming systems, laptop PCs, tablet PCs, netbooks, e-readers and the like. As the use of touch-screen input/output interfaces continues to increase, there is a continuing need for improved display sub-systems, touch sensor sub-systems, and/or touch-screen input/output interface sub-systems.

### SUMMARY OF THE INVENTION

The present technology may best be understood by referring to the following description and accompanying drawings that are used to illustrate embodiments of the present technology directed toward touch-screen input/output device techniques.

In one embodiment, the touch-screen input/output device includes a touch sensor overlaid on a display. A state machine implemented touch control module is communicatively coupled between the touch sensor and a general purpose processing unit. In one implementation, the state machine implemented touch control module includes a scan logic communicatively coupled to the touch sensor. An analog-to-digital converter is communicatively coupled to the scan logic. A sensing logic is communicatively coupled to the analog-to-digital converter. A threshold management logic is communicatively coupled between the sensing logic and the general purpose processing unit. In one implementation, the general purpose processing unit executes computing device executable instructions to implement an area detection function communicatively coupled to the threshold management. The general purpose processing unit also executes computing device executable instructions to implement a smart detection function communicatively coupled to the area detection function and one or more operating system drivers. The general purpose processing unit also executes computing device executable instructions to implement a cursor management function communicatively coupled to the smart detection function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary computing device according to the conventional art.

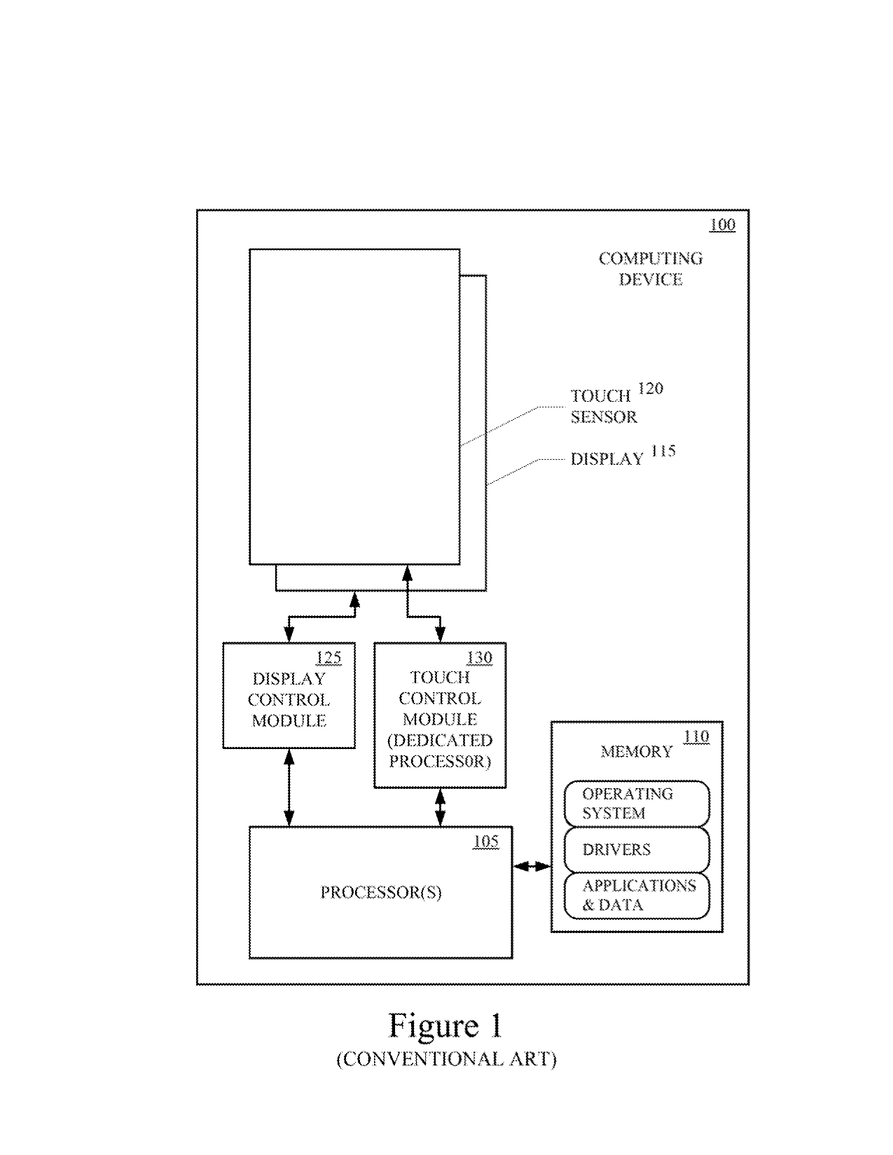

FIG. 2 shows a block diagram of a computing device, in according with one embodiment of the present technology.

FIG. 3 shows a block diagram of a more detailed representation of the touch sensor, touch sensor control module, and processor 205 of the computing device, in accordance with one embodiment of the present technology.

FIG. 4 shows a block diagram of a more detailed representation of the touch sensor, touch sensor control module, and processor of the computing device according to the conventional art.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

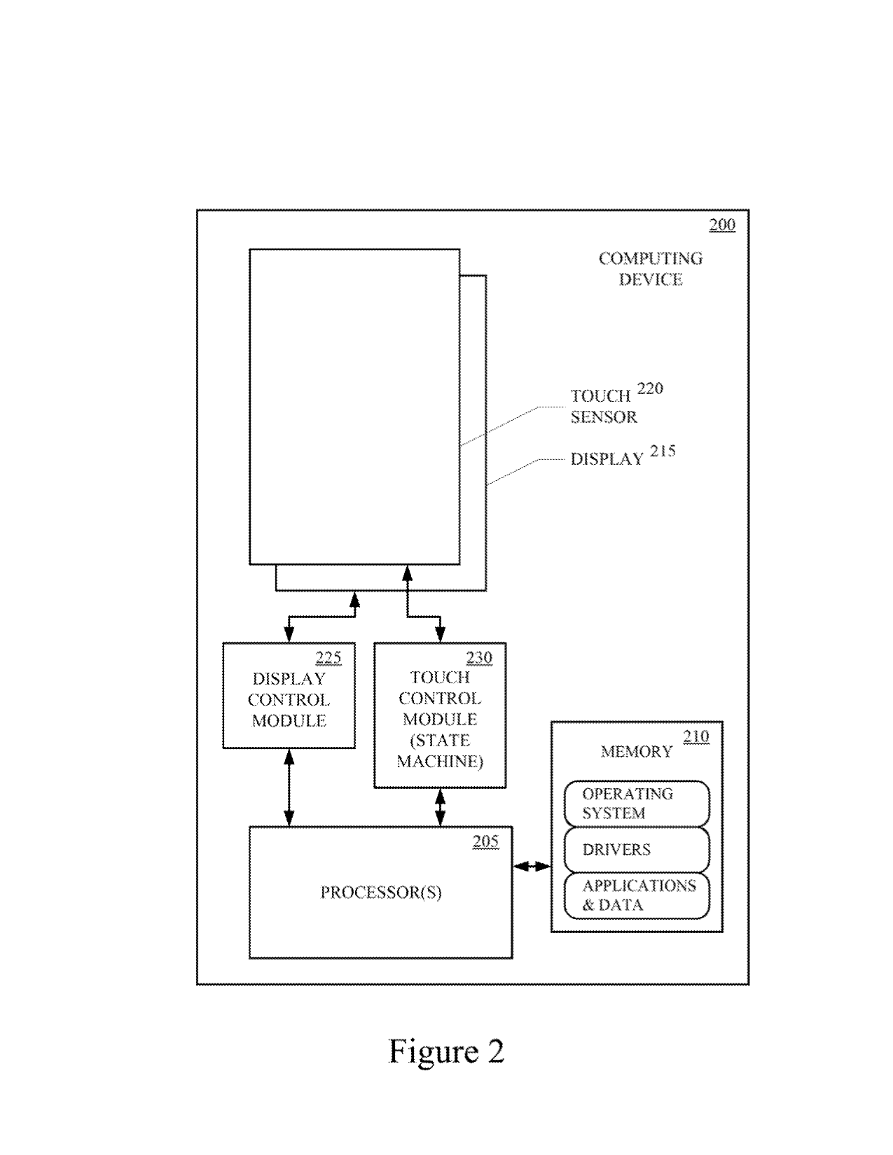

Referring to FIG. 2, a computing device, in according with one embodiment of the present technology, is shown. The computing device 200 includes one or more processors 205 communicatively coupled to one or more memories 210, and one or more peripheral devices including a touch-screen input/output device 215-235. The computing device also typically includes numerous other devices, components, subsystems, peripheral and/or the like, which are not necessary to an understanding of embodiments of the present technology and therefore are not discussed herein.

The touch-screen input/output device 215-235 includes a display 215 and a touch sensor 220 overlaid on the display 215. The display 215 is communicatively coupled to one or more processors 205 through its corresponding display control module 225. The touch sensor 220 is communicatively coupled to one or more processors 205 through its corresponding touch sensor control module 230. The touch sensor control module 230 is implemented as a state machine. It is appreciated that the display 215, display control module 225, touch sensor 220, and touch sensor control module 230 may be implemented as an external peripheral or may be implemented as an internal peripheral. It is further appreciated that there are a number of other ways that the display 215, display control module 225, touch sensor 220, and touch sensor control module 230 may be implemented. For example, the touch sensor 220 and display 215 may be implemented as an external peripheral, and the display control module 225 and touch control module 230 may be implemented internally integrated with other subsystems the computing device 200.

The display control module 225 converts video data into a serial bit stream output in a synchronous video display signal. The touch sensor 220 may be resistive, capacitive, surface acoustic wave, or the like panel. In a capacitive touch sensor, an object such as the finger of a user alters the localized capacitance on the sensor. The touch sensor control module 230 can determine a touch event and the location of the touch indirectly from the change in the capacitance. In one implementation, the touch sensor control module 230 determines the capacitance by scanning an array of charged elements arranged in a matrix of rows and columns. The touch sensor control module 230 determines the capacitance at the intersection of each row and column of the touch sensor. Similarly, in a resistive touch sensor 220 a change in the electrical field across a matrix of resistive elements is determined. Typically the touch location is determined as an x-y coordinate based position.

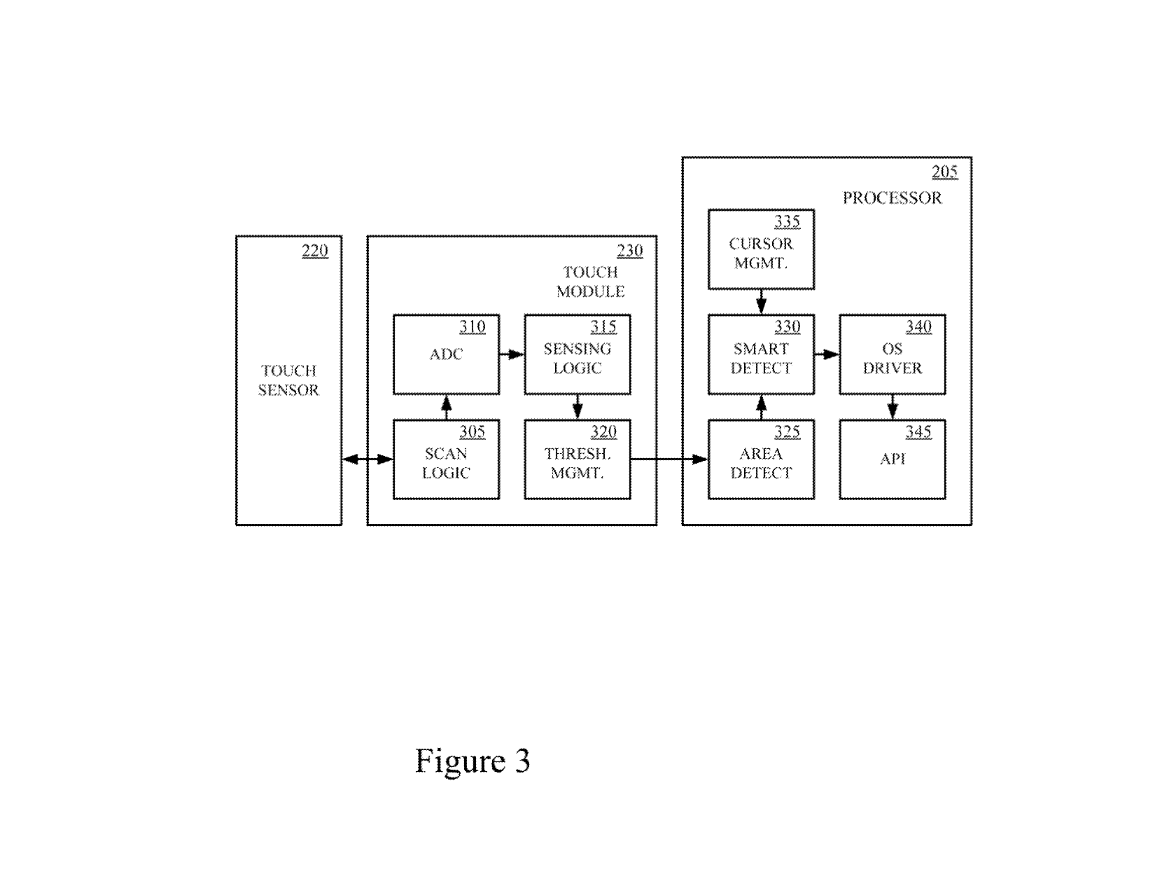

Referring now to FIG. 3, a more detailed representation of the touch sensor 220, touch sensor control module 230, and processor 205 of the computing device, in accordance with one embodiment of the present technology, is shown. The touch sensor control module 230 may include scan logic 305, an analog-to-digital converter 310, sensing logic 315, and threshold management logic 320. Therefore, the touch module 230 is state machine, and does not include a dedicated processor.

The scan logic 305 is communicatively coupled to the touch sensor panel 220 and the analog-to-digital converter 310. The scan logic 305 controls the sensing of the capacitive elements along the grid of columns and rows to provide charge levels across a serial port interface (SPI) to the analog-to-digital converter 310. The analog-to-digital converter 310 converts the charge levels to digital charge data regarding the capacitive surface of the touch sensor for each touch sensor scan interval. The sensing logic 315 detects potential touch events and potential touch event location data for each touch sensor scan interval. The threshold management 320 compares the potential touch events and potential touch event location data to predetermined limits to determine touch events and locations that satisfy a predetermined level of accuracy. Therefore, the state machine completes minimal processing to transmit reliable touch events and location information.

The general purpose processor 205 executes sets of computing device executable instructions to implement an area detect utility 325, a smart detect utility 330, a cursor management utility 335, one or more operating system drivers 340, one or more application programming interfaces 345, an operating system, one or more user mode applications, and/or the like. The operating system driver 340 receives information indicating valid touch events and the x-y coordinates of the valid touch events. The operating system driver 340 may convert the valid touch events and the x-y coordinates thereof to appropriate inputs to one or more user applications through corresponding application programming interfaces 345.

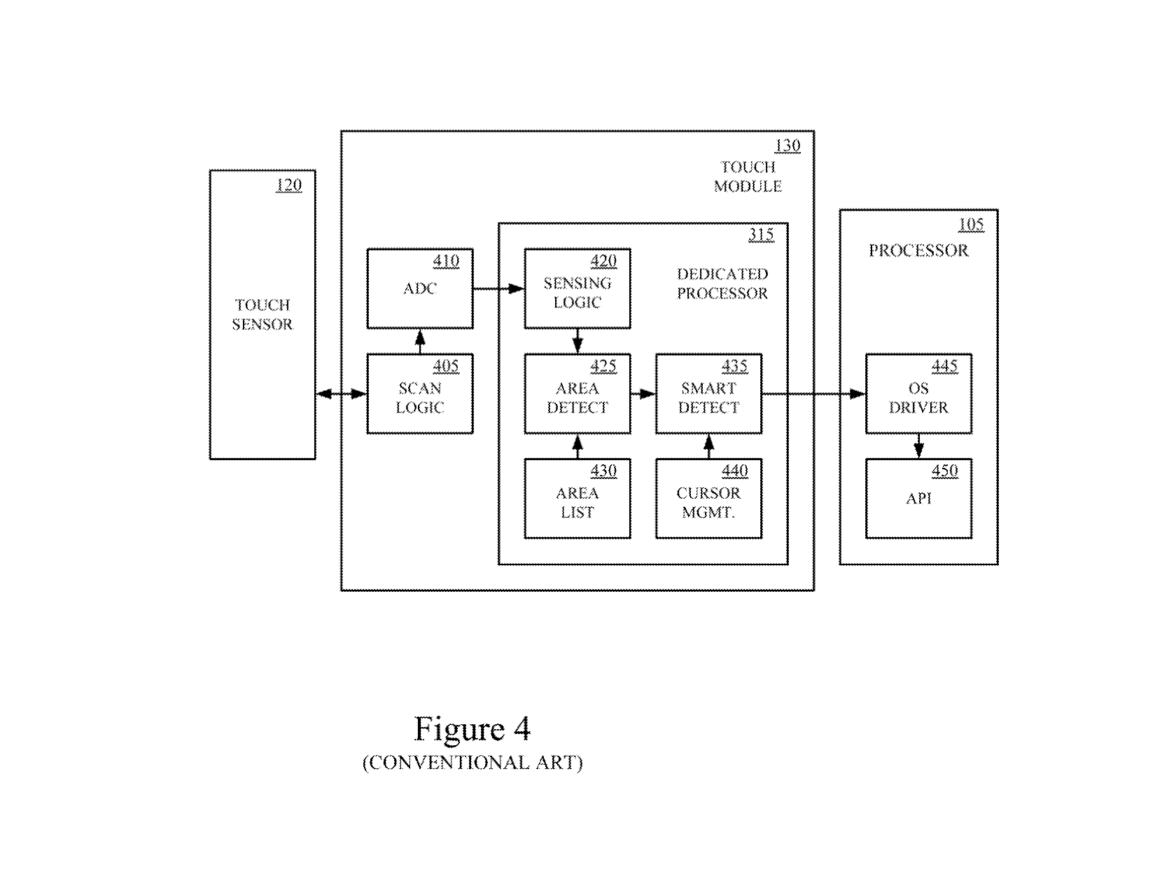

In comparison, a more detailed representation of the touch sensor 120, touch sensor control module 130, and processor 105 of the computing device 100, according to the conventional art, is shown in FIG. 4. The touch sensor control module 130 may include scan logic 405, an analog-to-digital converter (ADC) 410, and a dedicated processor (e.g., microcontroller, embedded processor) 415. The scan logic 405 is communicatively coupled to the touch sensor panel 120 and the analog-to-digital converter 410. The scan logic 405 controls the sensing of the capacitive elements along the grid of columns and rows to provide charge levels across a serial port interface (SPI) to the analog-to-digital converter 410. The analog-to-digital converter 410 converts the charge levels to digital charge data regarding the capacitive surface of the touch sensor for each touch sensor scan interval. The dedicated processor 415 receives the digital charge data for the touch sensor from the analog-to-digital converter 410 across a serial port interface (SPI). The dedicated processor 415 converts the data to touch events and location information for each touch sensor scan interval. The dedicated processor 415 provides event detection, area detection, tracking, noise elimination, and other communication/scheduling functions. In one implementation, the dedicated processor 415 of the touch sensor control module 130 may be a 32-bit microcontroller. The dedicated processor may include sensing logic 420, area detection logic 425, area list data 430, smart detection logic 435, and cursor management 440.

The general purpose processor 105 executes sets of computing device executable instructions to implement one or more operating system (OS) drivers 445, one or more application programming interfaces (API) 450, an operating system, one or more user mode applications and/or the like. The operating system driver 445 receives information indicating valid touch events and the x-y coordinates of the valid touch events. The operating system driver 445 may convert the valid touch events and the x-y coordinates thereof to appropriate inputs to one or more user applications through corresponding application programming interfaces 450.

Referring again to FIG. 3, the state machine implementation of the touch screen control module 320 is adapted to eliminate potential touch events and locations that do not satisfy the predetermined accuracy level. Accordingly, the state machine transmits reliable touch data and does not wake up the general purpose processor 205 for data that has a substantial likelihood of being inaccurate. Embodiments therefore eliminate many time consuming and computationally heavy processing tasks for the touch sensor control module 230, and pushes them to the general purpose processor 205. The operating system can then decide how fast and accurate results are needed from the touch-screen input/output device and will apply the necessary amount of processing resources to the tasks. Configuration, fine tuning and updates for touch screen performance can advantageously be done with operating system updates and there is little or no need to change any firmware in the touch screen control module 230. By eliminating the need for a dedicated processor in the touch sensor control module 230 there are other components like volatile memory, non-volatile memory, clocks, power regulators and the like, needed to run a microcontroller, that are eliminated. Accordingly, the price of the touch-screen input/output device may be reduced. In addition, the state machine requires less power to perform the scanning of data compared to the dedicated processor. Furthermore, the general purpose processor 205 and the operating system are already running and are typically performing many other tasks. The additional processing power required for touch detection specific tasks in the general purpose processing unit 205 are relatively little compared to the other tasks already running in the system. The reduced power advantageously extends the operating time of battery powered devices such as smart phones, portable game consoles and the like.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A device comprising:
a touch sensor overlaid on a display;
a state machine implemented touch control module communicatively coupled between the touch sensor and a general purpose processing unit.

2. The device of claim 1, wherein the state machine implemented touch control module comprises:
a scan logic communicatively coupled to the touch sensor;
an analog-to-digital converter communicatively coupled to the scan logic;
a sensing logic communicatively coupled to the analog-to-digital converter; and
a threshold management communicatively coupled between the sensing logic and the general purpose processing unit.

3. The device of claim 2, wherein the general purpose processing unit executes one or more set of computing device executable instructions to implement:
an area detection function communicatively coupled to the threshold management;
a smart detection function communicatively coupled to the area detection function and one or more operating system drivers; and
a cursor management function communicatively coupled to the smart detection function.

4. A method comprising:
scanning, by state machine implemented touch sensor control module, to determine charge levels from a touch sensor;
converted, by state machine implemented touch sensor control module, the charge levels to digital charge data;
detecting, by state machine implemented touch sensor control module, potential touch events and potential touch event location data from the digital charge data; and
comparing, by state machine implemented touch sensor control module, the potential touch events and potential touch event location data to predetermined limits to determine touch events and locations that satisfy a predetermined level of accuracy.

5. The method according to claim 4, further comprising scanning, by a scan logic of the touch sensor control module, to determine the charge levels from the touch sensor.

6. The method according to claim 4, further comprising converted, by an analog-to-digital converter of the touch sensor control module, the charge levels to the digital charge data.

7. The method according to claim 4, further comprising detecting, by sensing logic of the touch sensor control module, the potential touch events and potential touch event location data from the digital charge data.

8. The method according to claim 4, further comprising comparing, by a threshold management of the touch sensor control module, the potential touch events and potential touch event location data to predetermined limits to determine touch events and locations that satisfy the predetermined level of accuracy.

9. The method according to claim 4, further comprising executing one or more set of computing device executable instructions by a general purpose processing unit to implement:
an area detection function communicatively coupled to the threshold management;
a smart detection function communicatively coupled to the area detection function and one or more operating system drivers; and
a cursor management function communicatively coupled to the smart detection function.
